(19) United States
(12) Patent Application Publication
(10) Pub. No.: US 2023/0186221 A1
(43) Pub. Date: Jun. 15, 2023

(54) SYSTEMS AND METHODS FOR JOB ROLE QUALITY ASSESSMENT

(71) Applicant: FMR LLC, Boston, MA (US)

(72) Inventors: Connor Qualls, Boston, MA (US); Apurva Jani, Boston, MA (US)

(21) Appl. No.: 17/550,684

(22) Filed: Dec. 14, 2021

(51) Int. Cl. G06Q 10/06

(52) U.S. Cl. CPC G06Q 10/06393; G06Q 10/0635

(57) ABSTRACT

A computer-implemented method is provided for evaluating quality of a job role in a user group comprising a plurality of users. The method includes determining from a plurality of resources accessible by the users in the user group (i) a plurality of assigned resources included with the job role and (ii) a plurality of outlier resources outside of the job role. The method also includes calculating an included access score for the job role with respect to the assigned resources and an outlier access score for the job role with respect to the outlier resources. The method further includes calculating a weighted sum of the included access score and the outlier access score, where the weighted sum represents the quality of the job role.

### TECHNICAL FIELD

This application relates generally to systems, methods and apparatuses, including computer program products, for evaluating the quality of a job role in an enterprise.

### BACKGROUND

It is critical for a business organization to be able to evaluate (e.g., objectively measure) the quality/health of a particular job role within the organization. Determining the quality/health of a job role is important as it is an indicator of how close the job role is to the ideal standard. As a job role is a list of accesses to resources to which associates are granted, the ideal job role is one that strikes an optimal balance between including enough access to cover most associates' needs and not including too much access most associates don't need. Consequently, an objective measure of the health of a job role can be used by an organization to determine what access should and should not be included in the job role.

### SUMMARY

The present invention features systems and methods for quantitatively evaluating the health (i.e., quality) of a job role in an enterprise. The instant approach provides a granular evaluation of job role health by considering many factors associated with a job role, such as taking into account of various types of resources accessed within the job role, differentiating between widely-accessed resources and scarcely-accessed resources, and accounting for their associated risks.

In one aspect, a computer-implemented method is provided for evaluating the quality of a job role in a user group comprising a plurality of users. The method includes determining, by a computing device, from a plurality of resources accessible by the users in the user group (i) a plurality of assigned resources included with the job role and (ii) a plurality of outlier resources outside of the job role. The method also includes calculating, by the computing device, an included access score for the job role based on (i) a plurality of percentages of the users in the user group accessed corresponding ones of the plurality of assigned resources and (ii) a plurality of risk ratings for corresponding ones of the plurality of assigned resources. Each percentage represents a popularity of the corresponding assigned resource, and each risk rating represents a criticality of the corresponding assigned resource. The included access score is adapted to be higher when an assigned resource is at least one of popular among the plurality of users or critical. The method also includes calculating, by the computing device, an outlier access score for the job role based on (i) a plurality of percentages of the users in the user group accessed corresponding ones of the plurality of outlier resources, (ii) a total number of the plurality of users in the user group, and (iii) a plurality of risk ratings for corresponding ones of the plurality outlier resources. Each percentage represents a popularity of the corresponding outlier resource, and each risk rating represents a criticality of the corresponding outlier resource. The outlier access score is adapted to be higher when an outlier resource is at least one of less popular among the plurality of users or less critical. The method further includes calculating, by the computing device, a weighted sum of the included access score and the outlier access score, where the weighted sum represents the quality of the job role.

In another aspect, a computer-implemented system is provided for evaluating quality of a job role in a user group comprising a plurality of users. The system includes a management module for tracking a plurality of assigned resources included with the job role and a plurality of outlier resources outside of the job role. The system also includes a health evaluation engine configured to calculate an included access score for the job role based on (i) a plurality of percentages of the users in the user group accessed corresponding ones of the plurality of assigned resources, and (ii) a plurality of risk ratings for corresponding ones of the plurality of assigned resources. Each percentage represents a popularity of the corresponding assigned resource, and each risk rating represents a criticality of the corresponding assigned resource. The included access score is adapted to be higher when an assigned resource is at least one of popular among the plurality of users in the user group or critical. The health evaluation engine is also configured to calculate an outlier access score for the job role based on (i) a plurality of percentages of the users in the user group accessed corresponding ones of the plurality of outlier resources, (ii) a total number of the plurality of users in the user group, and (iii) a plurality of risk ratings for corresponding ones of the plurality outlier resources. Each percentage represents a popularity of the corresponding outlier resource, and each risk rating represents a criticality of the corresponding outlier resource. The outlier access score is adapted to be higher when an outlier resource is at least one of less popular among the plurality of users in the user group or less critical. The health evaluation engine is configured to calculate a weighted sum of the included access score and the outlier access score, where the weighted sum represents the quality of the job role.

Any of the above aspects can include one or more of the following features. In some embodiments, a higher risk rating for an assigned resource indicates a higher criticality of the assigned resource. In some embodiments, a higher risk rating for an outlier resource indicates a lower criticality of the outlier resource.

In some embodiments, the included access score is calculated by computing a plurality of actual scores for corresponding ones of the assigned resources and computing a total actual score by aggregating the plurality of actual scores. Each actual score is computed by multiplying the risk rating for the corresponding assigned resource with the percentage of the plurality of users accessed the corresponding assigned resource. In some embodiments, calculating the included access score further comprises computing a total possible score by aggregating the plurality of risk ratings for corresponding ones of the assigned resources and computing the included access score as a percentage of the total actual score divided by the total possible score.

In some embodiments, the outlier access score is calculated by computing a plurality of actual scores for corresponding ones of the outlier resources. Each actual score can be calculated as

$$mp ( \frac{1}{1 - \frac{1}{\# \_users}} ( 1 - \% \_users ) ) ,$$

where mp represents the risk rating for the corresponding outlier resource, #_users represents the total number of users in the user group, and %_users represents the percentage of the plurality of users in the user group accessed the corresponding outlier resource. In some embodiments, calculating the outlier access score further comprises computing a total actual score by aggregating the plurality of actual scores. In some embodiments, calculating the outlier access score further comprises computing a total possible score by aggregating the plurality of risk ratings for corresponding ones of the outlier resources and computing the outlier access score as a percentage of the total actual score divided by the total possible score.

In some embodiments, the included access score and the outlier access score have equal weights in the weighted sum. In some embodiments, the included access score and the outlier access score have different weights in the weighted sum.

In some embodiments, one or more resources accessible by the users is automatically added or removed to ensure that the weighted sum exceeds a predefined health threshold.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary diagram of a system used in a computing environment to determine the health of a job role in an organization, according to some embodiments of the present invention.

FIG. 2 shows an exemplary process implemented by the system of FIG. 1 to evaluate the health of a job role of interest within an organization, according to some embodiments of the present invention.

FIG. 3 shows an exemplary graphical user interface (GUI) provided by the system of FIG. 1 to display the various health scores generated by the process of FIG. 2, according to some embodiments of the present invention.

FIG. 4 shows another exemplary graphical user interface (GUI) provided by the system 100 of FIG. 1 to display trends in job role health scores over time, according to some embodiments of the present invention.

### DETAILED DESCRIPTION

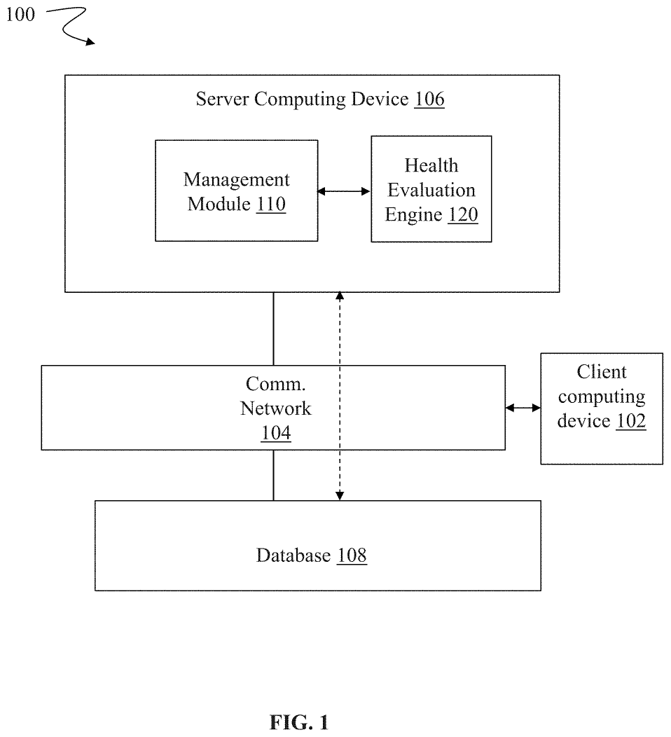

FIG. 1 shows an exemplary diagram of a system 100 used in a computing environment to determine the health of a job role in an organization, according to some embodiments of the present invention. As shown, the system 100 generally includes a client computing device 102, a communication network 104, a server computing device 106 and a database 108.

The client computing device 102 connects to the communication network 104 to communicate with the server computing device 106 and/or the database 108 to provide inputs and receive outputs relating to the process of job role health determination as described herein. For example, the client computing device 102 can display to a user a detailed graphical user interface (GUI) that allows the user to (i) enter specific information of a job role of interest, (ii) review evaluation results generated from the analysis methods and systems described herein and/or (iii) modify inputs and/or outputs generated by the system 100. An exemplary user of the system 100 can be a manager who is responsible for managing job role accesses as well as the associates assigned to a job role. The manager can use the system 100 to inform his/her decisions to remove and/or add accesses to resources or associates to certain job roles. Exemplary client computing devices 102 include but are not limited to desktop computers, laptop computers, tablets, mobile devices, smartphones, and internet appliances. In some embodiments, a user accesses the server computing device 106 via an Application Programming Interface (API) connected to the client computing device 102. It should be appreciated that other types of computing devices that are capable of connecting to the components of the system 100 can be used without departing from the scope of invention. Although FIG. 1 depicts a single client device 102, it should be appreciated that the system 100 can include any number of client devices.

The communication network 104 enables components of the system 100 to communicate with each other to perform the process of job role health evaluation. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 100 to communicate with each other.

The server computing device 106 is a combination of hardware, including one or more processors and one or more physical memory modules and specialized software engines that execute on the processor of the server computing device 106, to receive data from other components of the system 100, transmit data to other components of the system 100, and perform functions as described herein. As shown, the processor of the server computing device 106 executes a management module 110 and a health evaluation engine 120, where the sub-components and functionalities of these components are described below in detail. In some embodiments, the components 110, 120 of the server computing device 106 are specialized sets of computer software instructions programmed onto a dedicated processor in the server computing device 106 and can include specifically-designated memory locations and/or registers for executing the specialized computer software instructions.

The database 108 is a computing device (or in some embodiments, a set of computing devices) that is coupled to and in data communication with the server computing device 106 and is configured to provide, receive and store various types of data needed and created for evaluating the health of a job role, as described below in detail. In some embodiments, all or a portion of the database 108 is integrated with the server computing device 106 or located on a separate computing device or devices. For example, the database 108 can comprise one or more databases, such as MySQL™ available from Oracle Corp. of Redwood City, Calif.

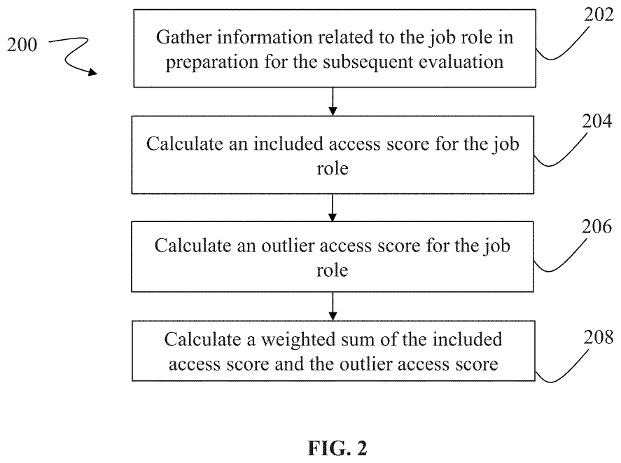

FIG. 2 shows an exemplary process 200 implemented by the system 100 of FIG. 1 to evaluate the quality (hereinafter referred to as “health”) of a job role of interest within an organization, according to some embodiments of the present invention. The job role of interest can be specified by a user of the system 100 via his or her corresponding client device 102. Upon receiving the description of the job role of interest, the management module 110 of the server computing device 106 can gather information related to the job role in preparation for the subsequent evaluation (step 202), such as determining the employees in a user group of the organization who are assigned to the job role. The user group can be a particular sector of the organization specified by the user, such as a particular Business Unit, Business Group and/or Enterprise Level. The management module 110 can also determine one or more assigned resources included with the job role (“included resources”). For each included resource, the employees of the job role have permission to access that resource within the job role. Thus each included resource is job-role compliant. The management module 110 can further determine one or more resources outside of the job role that are nonetheless accessed by the employees of the job role (“outlier resources”). For each outlier resource, the employees of the job role do not have explicit permission to access the resource within the job role. Thus, each outlier resource is job-role noncompliant. In some embodiments, the management module 110 obtains the data from various sources in the organization, such as from the database 108 (e.g., an enterprise entitlement repository of the database 108) and/or from other human resource management systems maintained by the organization (e.g., an enterprise job role management system).

The health evaluation engine 120 is configured to calculate an included access score for the job role based on the information determined by the management module 110 (step 204). In general, an included access score considers risk as a part of its job role health calculation, where a higher risk access of an included resource impacts the resulting health score more than a lower risk access. Further, an included access score can differentiate between widely-held access and scarcely-held access by, for example, not rewarding scarcely-held access within the job role.

In some embodiments, for each included resource, a risk rating (mp) is given to that resource to represent a criticality level of the resource. For example, the risk rating (mp) can be on a scale of 1 to 4, with 1 being an included resource of low criticality and low risk to 4 being an included resource of high criticality and high risk. Thus, a higher risk rating of an included resource indicates a higher criticality of that resource. The risk rating (mp) can be represented below as:

$$mp = \{ \begin{matrix}4 if Critical \\ 3 if High \\ 2 if Medium \\ 1 if Low\end{matrix} \qquad Equation 1$$

In addition, the percentage of employees within a specific user group of the job role who have accessed each included resource (%_access) is determined. This percentage represents the popularity of each included resource among employees of the job role. For each included resource, the health evaluation engine 120 can further compute an actual score (ap) by multiplying the risk rating for that resource with the percentage of employees who accessed the same resource, as shown by the following equation:

ap=mp*(%_access) Equation 2.

The health evaluation engine 120 can subsequently compute a total access score for the included resources (TP_inc) by aggregating the actual scores for all the included resources calculated at Equation 2, as shown below:

TP_inc=Σᵢ₌₁ⁿapᵢ Equation 3,

where n represents the number of included resources for the job role of interest.

Next, the health evaluation engine 120 calculates a total possible score for the included resources (TPP_inc) by aggregating the risk ratings of the included resources shown in Equation 1:

TPP_inc=Σᵢ₌₁ⁿmpᵢ Equation 4.

Finally, the health evaluation engine 120 calculates the included access score for the job role (JRH_inc) as a percentage of the total actual score (TP_inc) from Equation 3 divided by the total possible score (TPP_inc) from Equation 4, as shown below:

$${JRH}_{inc} = \frac{TP\_inc}{TPP\_inc} * 100. \qquad Equation 5$$

In general, the included access score (JRH_inc) is adapted to be higher when an included resource is popular among the employees of the job role and/or has a high criticality rating.

The health evaluation engine 120 is also configured to calculate an outlier access score for the job role of interest based on the information provided by the management module 110 (step 206). In general, an outlier access score also considers risk as a part of its job role health calculation, where higher risk access of outlier resources impacts the resulting health score more than lower risk access. Further, an outlier access score can differentiate between widely-held access and scarcely-held access by, for example, not punishing for widely-held outlier access without considering the risk associated with that access.

In some embodiments, for each outlier resource, a risk rating (mp) is given to that resource representing a criticality of the resource. For example, the risk rating (mp) can be on a scale of 1 to 4, with 4 being an outlier resource of low criticality and low risk to 1 being an outlier resource of high criticality and high risk. The risk rating (mp) can be represented below as:

$$mp = \{ \begin{matrix}1 if Critical \\ 2 if High \\ 3 if Medium \\ 4 if Low\end{matrix} \qquad Equation 6$$

Thus the risking rating for an outlier resource is inverse of that for an included resource, where a higher risk rating indicates a lower criticality of the outlier resource.

In addition, the percentage of employees (%_access) within the user group of the job role of interest who have accessed each outlier resource is determined. This percentage represents the popularity of each outlier resource among employees of the job role. The evaluation engine 120 can further determine the total number employees assigned to the job role (#_JR). For each outlier resource, the health evaluation engine 120 can compute an actual score (ap) using the following equation:

$$ap = mp * ( \frac{1}{1 - \frac{1}{{\#}_{JR}}} ( 1 - \% \_access ) ) . \qquad Equation 7$$

The health evaluation engine 120 can subsequently compute a total access score for the outlier resources (TP_out) by aggregating the actual scores for all the outlier resources calculated at Equation 7, as shown below:

TP_out=Σᵢ₌₁^{m}apᵢ Equation 8,

where m represents the number of outlier resources for the job role of interest.

Next, the health evaluation engine 120 calculates a total possible score for the outlier resources (TPP_out) by aggregating the risk ratings of the outlier resources shown in Equation 6, as shown below:

TPP_out=Σᵢ₌₁ⁿmpᵢ Equation 9.

Finally, the health evaluation engine 120 calculates the outlier access score for the job role (JRH_out) as a percentage of the total actual score (TP_out) from Equation 8 divided by the total possible score (TPP_out) from Equation 9, as shown below:

$${JRH}_{out} = \frac{TP\_out}{TPP\_out} * 100. \qquad Equation 10$$

In general, the outlier access score (JRH_out) is adapted to be higher when an outlier resource is less popular among the employees of the job role and/or has a lower criticality rating.

After the included access score for the job role of interest (JRH_inc) is computed at step 204 and the outlier access score (JRH_out) is computed at step 206, the health evaluation engine 120 is configured to compute a combined access score (JRH_total) at step 208. In some embodiments, the combined access score (JRH_total) is a weighted sum of the included access score (JRH_inc) and the outlier access score (JRH_out), as shown below:

JRHₜₒₜₐₗ=a*JRH_inc+b*JRH_out Equation 11,

where a is the weight assigned for the included access score and b is the weight assigned for the outlier access score. In some embodiments, both weights a and b are equal (i.e., 0.5). In alternative embodiments, weights a and b are different depending on the relative importance of each type of score in the overall health calculation. This combined score represents the total health/quality of the job role of interest. In some embodiments, the combined access score is normalized with respect to the number of employees in a job role used by the process 200. Since each job role can have different number of employees associated with it, normalization is applied to facilitate equitable comparison of the health of various job roles in an organization.

In some embodiments, if the management module 110 determines that there no employee access to the included resources, the health evaluation engine 120 assigns a default value of 0 to the included access score. In some embodiments, if the management module 110 determines that there is no employee access to the outlier resources, the health evaluation engine 120 assigns a default value of 100 to the outlier access health score. In some embodiments, if the management module 110 determines that there is no employee access to both the include resources and the outlier resources, the health evaluation engine 120 assigns a default value of 0 to the overall health score. In some embodiments, the various scores generated by process 200 of FIG. 2 are stored in the database 108 of the system 100 of FIG. 1 for future reference and analysis.

In an exemplary implementation of process 200, job role health is evaluated for a job role that includes 10 employees, access to 5 pieces of included resources (Accesses 1-5) and access to 2 pieces of outlier resources (Accesses 6 and 7). Below are two tables (Table 1 and Table 2) describing characteristics associated with these accesses, such as their corresponding criticality ratings (“Criticality Rating” column), numbers of employees who have accessed the corresponding resources (“Num Holders” column), and representations of these numbers as percentages of the employee pool in the job role (“% held” column).

For access to included resources shown in Table 1, the criticality ratings can be mapped to corresponding numerical values using the scale provided in Equation 1 (“mp” column), and the actual scores can be calculated using Equation 2 (“ap” column). Similar calculations can be performed for access to outlier resources shown in Table 2. Specifically, the criticality ratings can be mapped to corresponding numerical values using the scale provided in Equation 6 (“mp” column), and the actual scores can be calculated using Equation 7 (“ap” column).

TABLE 1
Characteristics of Accesses to Included Resources
Included Access

| Access | Criticality Rating | Num Holders | % Held | mp | ap |
|---|---|---|---|---|---|
| Access 1 | Critical | 0 | 0 | 4 | 0 |
| Access 2 | Critical | 1 | .1 | 4 | 0.4 |
| Access 3 | High | 9 | .9 | 3 | 2.7 |
| Access 4 | Medium | 8 | .8 | 2 | 1.6 |
| Access 5 | Low | 7 | .7 | 1 | 0.7 |

TABLE 2
Characteristics of Accesses to Outlier Resources
Outlier Access

| Access | Criticality Rating | Num Holders | % Held | mp | ap |
|---|---|---|---|---|---|
| Access 6 | Low | 9 | .9 | 4 | 0.44 |
| Access 7 | High | 1 | .1 | 2 | 2 |

Subsequently, the total access score (TP_inc) and total possible score (TPP_inc) for the included accesses are computed using the values of Table 1 and equations 3 and 4, respectively. More specifically, the total access score for the included accesses is computed as TP_inc=0+0.4+2.7+1.6+0.7=5.4 and the total possible score for the included accesses is computed as TPP_inc=4+4+3+2+1=14. The total access score (TP_out) and total possible score (TPP_out) for the outlier accesses are computed using the values of Table 2 and equations 8 and 9, respectively. More specifically, the total access score for the outlier accesses is computed as TP_out=0.44+2=2.44 and the total possible score for the outlier accesses is computed as TPP_out=4+2=6.

Next, the individual health score for the included accesses is computed using Equation 5 as JRH_inc=5.4/14*100=38.6. Similarly, the individual health score for the outlier accesses is computed using Equation 10 as JRH_out=2.44/6*100=40.7. Finally, the overall health score (JRH_total) for this job role is calculated as a weighted sum of the individual health scores for the included and outlier accesses using Equation 11. Assuming in this example that the weights are equal (i.e., 0.5), the overall health score is computed as JRH_total=0.5*38.6+0.5*40.7=39.7. Therefore, the overall health score for this exemplary job role is 39.7 computed using process 200 described above.

In general, process 200 of FIG. 2 can differentiate between widely-held and scarcely-held resources for both included and outlier resources. For example, the included, outlier and overall health scores generated by process 200 are adapted to reward access to included resources held by a large percentage of the employees and/or access to outlier resources held by a small percentage of the employees. The health scores are also adapted to punish access to included resources less widely-held and/or access to outlier resources more widely-held. Further, the health scores take the risk of accessing the resources into account, where higher risk accesses impact the scores more than lower risk accesses. The health scores are also interpretable in terms of having an individual score for each of the included and outlier resources. In general, the health scores of the present invention are well suit for comparing various job roles to each other, even when the job roles are vastly different from each other.

In another aspect, the various scores generated by the process 200 can be utilized by the system 100 to automatically reallocate resources for the purpose of improving these scores, such as by adding or removing one or more resources accessible by the users to ensure that the health scores exceed certain predefined thresholds. The health scores adjusted can be one or more of the included access score (from step 204 of process 200) in relation to included resources, the outlier access score (from step 206 of process 200) in relation to outlier resources, and the combined score (from step 208 of process 200) in relation to both types of resources. For example, an included access score is higher if access to an included resource is widely held by the employees in the job role. Thus, if an included resource is not widely held, the system 100 can remove access of that included resource from the job role. As another example, an outlier access score is higher if access to an outlier resource is scarcely held by the employees in the job role. Therefore, if an outlier resource is widely held, the system can add that outlier resource to the list of included resources for the job role. In general, the ideal job role is one where the included access is widely held (high %) by the employees in it, and the outlier access is scarcely held (low %) if it exists at all.

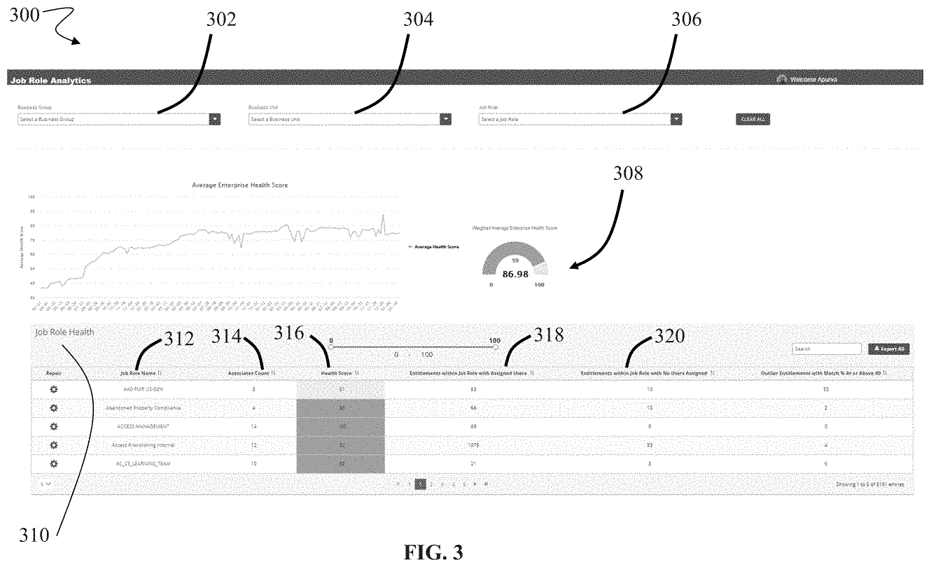

FIG. 3 shows an exemplary graphical user interface (GUI) 300 provided by the system 100 of FIG. 1 to display the various health scores generated by the process 200 of FIG. 2, according to some embodiments of the present invention. As shown, the GUI includes multiple drop down menus 302, 304, 306 that allow the user to specify the business group, the business unit and the job role of an organization, respectively, for which the health scores are generated. Once the scores are generated, the overall job role health score (from step 208 of process 200) can be illustrated in a chart section 308 of the GUI 300. More specifically, the plot in section 308 shows an exemplary average enterprise-wide health score over time. The GUI 300 can also display a table 310 listing various job roles in an enterprise (column 312), the number of associates assigned to each corresponding job role (column 314), the health score calculated for each corresponding job role (column 316), the number of pieces of access included within each corresponding job role that have at least one associate assigned to it (column 318), the number of pieces of access included within each corresponding job role that have no associates assigned to it (column 320), and the number of pieces of access not included in each corresponding job role that are assigned to at least 60% of the associates in the job role. Thus, the data in table 310 gives the user of system 100 insights into why the health scores in column 316 turned out the way they did for the corresponding job roles.

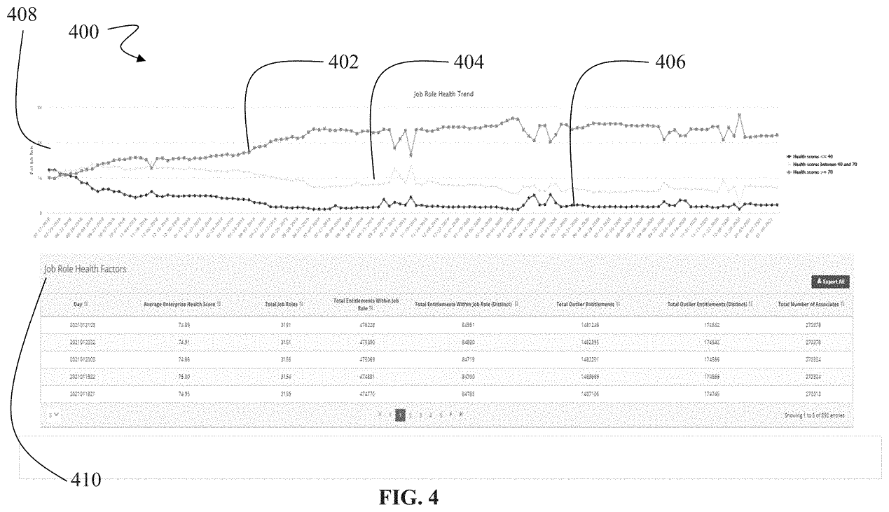

FIG. 4 shows another exemplary graphical user interface (GUI) 400 provided by the system 100 of FIG. 1 to display trends in job role health scores over time, according to some embodiments of the present invention. As shown, trending information for three exemplary job roles 402, 404, 406 are displayed in the plot section 408 of the GUI 400. In addition, these trends 402, 404, 406 can be categorized by color, such as green, yellow and red, respectively, where green represents health scores greater than or equal to about 70, yellow represents health scores between about 40 and about 70, and red represents health scores less than or equal to about 40. Additionally, the table section 410 of the GUI 400 shows daily statistics regarding the enterprise-wide job role environment. More specifically, each row of table 410 corresponds to a calendar day, where each row displays job role information including a daily average enterprise-wide health score, the daily total number of job roles in the enterprise, the daily total number of accesses included in job roles, the daily total number of accesses held by associates that isn't included in job roles, etc.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for evaluating quality of a job role in a user group comprising a plurality of users, the method comprising:
determining, by a computing device, from a plurality of resources accessible by the users in the user group (i) a plurality of assigned resources included with the job role and (ii) a plurality of outlier resources outside of the job role;
calculating, by the computing device, an included access score for the job role based on:
(i) a plurality of percentages of the users in the user group accessed corresponding ones of the plurality of assigned resources, each percentage representing a popularity of the corresponding assigned resource, and
(ii) a plurality of risk ratings for corresponding ones of the plurality of assigned resources, each risk rating representing a criticality of the corresponding assigned resource,
wherein the included access score is adapted to be higher when an assigned resource is at least one of popular among the plurality of users or critical;
calculating, by the computing device, an outlier access score for the job role based on:
(i) a plurality of percentages of the users in the user group accessed corresponding ones of the plurality of outlier resources, each percentage representing a popularity of the corresponding outlier resource,
(ii) a total number of the plurality of users in the user group, and
(iii) a plurality of risk ratings for corresponding ones of the plurality outlier resources, each risk rating representing a criticality of the corresponding outlier resource,
wherein the outlier access score is adapted to be higher when an outlier resource is at least one of less popular among the plurality of users or less critical; and
calculating, by the computing device, a weighted sum of the included access score and the outlier access score, the weighted sum representing the quality of the job role.

2. The computerized method of claim 1, wherein a higher risk rating for an assigned resource indicates a higher criticality of the assigned resource.

3. The computerized method of claim 1, wherein calculating the included access score comprises:
computing a plurality of actual scores for corresponding ones of the assigned resources, wherein each actual score is computed by multiplying the risk rating for the corresponding assigned resource with the percentage of the plurality of users accessed the corresponding assigned resource; and
computing a total actual score by aggregating the plurality of actual scores.

4. The computerized method of 3, wherein calculating the included access score further comprises:
computing a total possible score by aggregating the plurality of risk ratings for corresponding ones of the assigned resources; and
computing the included access score as a percentage of the total actual score divided by the total possible score.

5. The computerized method of claim 1, wherein a higher risk rating for an outlier resource indicates a lower criticality of the outlier resource.

6. The computerized method of claim 1, wherein calculating the outlier access score comprises computing a plurality of actual scores for corresponding ones of the outlier resources, each actual score calculated as:
$$mp ( \frac{1}{1 - \frac{1}{\# \_users}} ( 1 - \% \_users ) ) ,$$
wherein mp represents the risk rating for the corresponding outlier resource, #_users represents the total number of users in the user group, and %_users represents the percentage of the plurality of users in the user group accessed the corresponding outlier resource.

7. The computerized method of 6, wherein calculating the outlier access score further comprises computing a total actual score by aggregating the plurality of actual scores.

8. The computerized method of 7, wherein calculating the outlier access score further comprises:
computing a total possible score by aggregating the plurality of risk ratings for corresponding ones of the outlier resources; and
computing the outlier access score as a percentage of the total actual score divided by the total possible score.

9. The computerized method of claim 1, wherein the included access score and the outlier access score have equal weights in the weighted sum.

10. The computerized method of claim 1, wherein the included access score and the outlier access score have different weights in the weighted sum.

11. The computerized method of claim 1, further comprising automatically adding or removing one or more resources accessible by the users to ensure that the weighted sum exceeds a predefined health threshold.

12. A computerized system for evaluating quality of a job role in a user group comprising a plurality of users, the system comprising:
A management module for tracking a plurality of assigned resources included with the job role and a plurality of outlier resources outside of the job role; and
a health evaluation engine configured to:
calculate an included access score for the job role based on (i) a plurality of percentages of the users in the user group accessed corresponding ones of the plurality of assigned resources, each percentage representing a popularity of the corresponding assigned resource, and (ii) a plurality of risk ratings for corresponding ones of the plurality of assigned resources, each risk rating representing a criticality of the corresponding assigned resource, wherein the included access score is adapted to be higher when an assigned resource is at least one of popular among the plurality of users in the user group or critical;
calculate an outlier access score for the job role based on (i) a plurality of percentages of the users in the user group accessed corresponding ones of the plurality of outlier resources, each percentage representing a popularity of the corresponding outlier resource, (ii) a total number of the plurality of users in the user group, and (iii) a plurality of risk ratings for corresponding ones of the plurality outlier resources, each risk rating representing a criticality of the corresponding outlier resource, wherein the outlier access score is adapted to be higher when an outlier resource is at least one of less popular among the plurality of users in the user group or less critical; and
calculate a weighted sum of the included access score and the outlier access score, the weighted sum representing the quality of the job role.

13. The computerized system of claim 12, wherein the management module comprises (i) a data repository configured to store data related to a plurality of resources accessible by the plurality of users in the user group, and (ii) a processing engine configured to determine, from the plurality of resources, the assigned resources compliant to the job role and the outlier resources non-compliant to the job role.

14. The computerized system of claim 13, further comprising an automation engine configured to automatically add or remove one or more resources accessible by the plurality of users to ensure that the weighted sum exceeds a predefined health threshold.

15. The computerized system of claim 12, wherein the health evaluation engine is adapted to calculate the included access score by:
computing a plurality of actual scores for corresponding ones of the assigned resources, wherein each actual score is computed by multiplying the risk rating for the corresponding assigned resource with the percentage of the plurality of users accessed the corresponding assigned resource; and
computing a total actual score by aggregating the plurality of actual scores.

16. The computerized system of claim 15, wherein the health evaluation engine is adapted to calculate the included access score by further:
computing a total possible score by aggregating the plurality of risk ratings for corresponding ones of the assigned resources; and
computing the included access score as a percentage of the total actual score divided by the total possible score.

17. The computerized system of claim 12, wherein the health evaluation engine is adapted to calculate the outlier access score by computing a plurality of actual scores for corresponding ones of the outlier resources, each actual score being calculated as:
$$mp ( \frac{1}{1 - \frac{1}{\# \_users}} ( 1 - \% \_users ) ) ,$$
wherein mp represents the risk rating for the corresponding outlier resource, #_users represents the total number of users in the user group, and %_users represents the percentage of the plurality of users in the user group accessed the corresponding outlier resource.

18. The computerized system of claim 17, wherein the health evaluation engine is adapted to calculate the outlier access score by further computing a total actual score that aggregates the plurality of actual scores.

19. The computerized system of claim 18, wherein the health evaluation engine is adapted to calculate the outlier access score by further:
computing a total possible score by aggregating the plurality of risk ratings for corresponding ones of the outlier resources; and
computing the outlier access score as a percentage of the total actual score divided by the total possible score.

20. The computerized system of claim 12, wherein the included access score and the outlier access score have equal weights in the weighted sum.
